(19) United States
(12) Patent Application Publication
(10) Pub. No.: US 2004/0044757 A1
(43) Pub. Date: Mar. 4, 2004

(54) Flow-through provisioning with embedded control data

(76) Inventor: Albert D. Baker, Lincroft, NJ (US)

Correspondence Address: MENDELSOHN AND ASSOCIATES PC, 1515 MARKET STREET, SUITE 715, PHILADELPHIA, PA, 19102, US

(21) Appl. No.: 10/232,542

(22) Filed: Aug. 30, 2002

(51) Int. Cl. G06F 15/173

(52) U.S. Cl. 709/223

(57) ABSTRACT

In a system with multiple independent element management systems (EMSs) and their data, control, and service overlap issues, an Integrated Element Management System (IEMS) includes all the capabilities of individual element management systems, but offers additional synergies and features. The IEMS exists in the context of multiple vendor network elements with varying degrees of standardized Management Information Base (MIB) support and multiple EMSs. It minimizes the likelihood of inconsistent provisioning of network (i.e., service) elements resulting from multiple (and possibly inconsistent) parameter entry to independent network elements or EMSs by centrally managing a MetaMIB. The MetaMIB includes at least one authoritative, self-consistent, network-wide set of all parameters for multiple network elements of the end-to-end system. It also includes indicators for each parameter, for each network element, which reference how that data should be interpreted and presented between that element and the IEMS. The IEMS and a configuration management function (CMF) coordinate what actions should be taken in response to traps, events, failures, network element version changes, network topology changes, and network element replacement.

### BACKGROUND OF THE INVENTION

1. Field of the Invention

The present invention relates to flow-through provisioning and centralized Operations, Administration, Maintenance, and Provisioning (OAM&P) of distributed computer systems, such as distributed communications systems.

2. Description of the Related Art

As the bandwidth of communication channels increases, the tendency to share this bandwidth between multiple services (e.g., voice, data, video, and multimedia) increases. Correspondingly, the problem of coordinating the provisioning of network elements that source, transport, and terminate these services also increases. As the networks that support these services evolve, the number of parameters (also referred to in the art as variables or objects) becomes significant, and the problem of administration of data becomes especially acute.

Standards have been developed for the remote administration of network elements. Such standards define a protocol for remotely reading the state/status and writing the configuration of network elements. Associated with these protocols are proprietary and industry-standard definitions of parameters that can be read and controlled for network elements. For a network element, these parameters may be grouped into a data structure called a Management Information Base (MIB). For industry-standard network elements, industry-standard MIBs have been defined.

Using these standards, in theory, it is possible to build management systems that control the various elements of a shared-services network. Unfortunately, industry-standard MIBs are lacking for many network elements. Additionally, for cost or performance reasons, vendors of those elements that are covered by industry-standard MIBs sometimes choose to implement only a subset (e.g., fewer parameters) or a more economical modification to the standard (e.g., more compact parameters).

For example, the maximum number of POTS (Plain Old Telephone Service) ports supported by customer equipment in a communication network may vary from customer to customer depending on the manufacturer and model of each customer's equipment. One standard for communication networks defines a parameter for the maximum number of POTS ports as having a format of Integer 32 (i.e., four octets long). However, some equipment might support a maximum of only 4, 8, or 16 POTS ports. These values could easily be represented within the dynamic range of one octet. As such, a manufacturer of such equipment might be hesitant to allocate four octets to this parameter.

As a result, an Element Management System (EMS) may be available from the manufacturer of such equipment that will properly manage their own elements, but which might not support the pseudo-standard implementation provided by other manufacturers' equipment. The likelihood of consistent and error-free provisioning of the full system thus decreases substantially in this circumstance, particularly when values for these same parameters may be set by different configuration systems (i.e., element management systems or provisioning systems).

### SUMMARY OF THE INVENTION

The present invention relates to the management of computer systems, such as distributed communications system, having one or more system elements. The problems in the prior art are addressed in accordance with the principles of the present invention by managing at least one element parameter, whose representation (e.g., format) may vary from element to element in a computer system, using a pre-defined system-level representation. A representation that applies to only a subset of the elements in a system is referred to herein as an “element-specific” representation, while a system-level representation that does not depend on any particular element is referred to herein as an “element-independent” representation.

For each parameter having an element-specific representation that differs from the element-independent representation for that parameter, the invention involves a mapping between the element-independent representation and the element-specific representation. These mappings enable automatic translation, for a particular system element, of an element parameter from its element-independent representation into the corresponding element-specific representation for use by the particular system element.

In a communications system having one or more elements, each with its own element-specific Element Management System (EMS), the present invention may be embodied in an Integrated EMS (IEMS) that offers additional synergies and features that are not available when the system includes only conventional EMSs. The IEMS may be implemented in the context of multiple vendor network elements with varying degrees of standardized Management Information Base (MIB) support and multiple EMSs. The IEMS minimizes the likelihood of inconsistent provisioning of network (i.e., service) elements resulting from multiple (and possibly inconsistent) parameter entry to independent network elements or EMSs by centrally managing a MetaMIB. The MetaMIB includes at least one authoritative, self-consistent, network-wide set of all parameters for multiple network elements of the end-to-end network. It also includes indicators for each parameter, for each network element, which reference how that data should be interpreted and presented between network elements and IEMS. The IEMS and a Condition Management Function (CMF) determine, as a function of the information in the MetaMIB, what actions should be taken in response to traps, events, failures, network element version changes, network topology changes, and network element replacement.

### BRIEF DESCRIPTION OF THE DRAWINGS

Other aspects, features, and advantages of the present invention will become more fully apparent from the following detailed description, the appended claims, and the accompanying drawings in which:

FIG. 1 depicts an exemplary prior art shared services network, specifically for VoDSL, including representative element management systems (EMSs).

FIG. 2 depicts an exemplary shared services network according to one embodiment of the present invention.

FIG. 3 depicts an exemplary condition-handling process executed by the Condition Management Function (CMF) of the Integrated Element Management System (IEMS) of FIG. 2.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

Standards have been developed for the remote administration of network elements, notably Simple Network Management Protocol (SNMP) and the more recent International Standards Organization (ISO) Open Systems Interconnect (OSI) Common Management Information Protocol (CMIP). Such standards define a protocol for remotely reading the state/status and writing the configuration of network elements. They also define a methodology for central notification and management of anomalies or faults in network elements via threshold exception alarms and status polling.

Associated with these protocols are proprietary and industry-standard definitions of parameters that can be read and controlled for network elements. For SNMP, for example, these parameters are grouped for a network element into a data structure called a Management Information Base (MIB). For industry-standard network elements, industry-standard MIBs have been defined.

For example, for routers, bridges, hubs, and related equipment, the World Wide Web Consortium (W3C) Request for Comment #1213 (RFC1213) defines under MIB-II a number of status and configuration parameters that can be read and set via a standard SNMP management station. It is incumbent on vendors of various network elements to support the relevant standardized MIBs or relevant MIB subsets to allow for management of these devices via standard network management systems.

Using these standards, in theory, it is possible to build management systems that have control over the various elements of a shared services network. However, in reality, industry-standard MIBs are lacking for many network elements. Additionally, for cost or performance reasons, vendors of those elements that are covered by industry-standard MIBs sometimes choose to implement only a subset (e.g., fewer parameters) or a more economical modification to the standard (e.g., more compact parameters). An Element Management System (EMS) may be available from the vendor of these elements that will properly manage their own elements, but which might not support the pseudo standard implementation provided by other vendors' elements. Ultimately, a system operator is forced into manually provisioning and monitoring sets of elements via separate element management systems. The likelihood of consistent and error-free provisioning of the full system thus decreases substantially in this circumstance, particularly when these same parameters may be set by different configuration systems (i.e., element management systems or provisioning systems).

For example, in the context of Voice over xDSL (VoDSL) systems, broadband voice and data services are provided. Popular digital loop carrier (DLC) solutions for VoDSL typically involve an EMS for each major element of the system. Also typically, the service provider is required to manually provision the system by interfacing with each EMS directly and using, for example, paper printouts of provisioning parameter values from one system to verify the proper setting of corresponding parameters values in another system.

A VoDSL system serves as another example of the benefit of parameter consistency checking across EMSs. In typical VoDSL systems, the Customer Premises Interworking Function (CP-IWF) which resides in the Integrated Access Device (IAD) at a business or consumer residence and the Central Office Interworking Function (CO-IWF) in the Voice Gateway at the headend or central office should be provisioned with the same Virtual Path Identifier/Virtual Circuit Identifier (VPI/VCI) or else communication between them cannot occur. Further, the CO-IWF, which is the conversion point between broadband and narrowband formats within the Voice Gateway, should be able to associate packet voice channels that traverse the Voice Virtual Circuit (VC) with the Time Division Multiplex (TDM) service module's address format, i.e., a Line Circuit Address (LCA) as specified in Bellcore's GR-303 IDLC specification. Other parametric overlaps can be quickly identified, such as Signal Type and Line State. For example, the signaling type provisioned in the IAD should be equal to that expected from the TDM feeder (GR-303) to the Voice Gateway (VG) to avoid failure, and Line States should be synchronized to prevent calls being made on an out-of-service facility, and the directory number should be coordinated between the LAD and the Class 5 Switch. Note that the VG could either be external to a DSLAM or alternatively could be incorporated within a DSLAM circuit pack. In the latter case, the TDM feeder would be terminated at the DSLAM circuit pack. Clearly, the critical provisioning parameters should be consistent, or else calls or data services will fail or be misrouted. Further, the voice gateway function should be explicitly synchronized with the data provided to the IAD and the Class 5 Switch for proper operation. Thus there exist four separate EMSs for provisioning the end-to-end Voice over DSL blended service in this example; one for the IAD, one for the Digital Subscriber Line Access Multiplexer (DSLAM) which incorporates the CO-IWF, one for the Voice Gateway and one for the Class 5 Switch. It is not uncommon in VoDSL systems to have a unique EMS for each network element although some EMSs might serve multiple network elements.

To reduce the inconvenience of having multiple EMSs and support the consistent entry of common parameters across these EMSs, it is possible to co-locate the EMSs, and have an EMS coordinator check the provisioning data from each EMS manually, and enter data separately to each EMS in an attempt to achieve consistent provisioning. However, this provides substantial opportunity for operator-induced error and expensive troubleshooting as a consequence.

Another problem in the current art is the management of anomalies and exceptions such as events, thresholds, and traps. Generally, these system occurrences can either be managed automatically (e.g., via a network element reset or via a condition or occurrence handler that involves actions associated with multiple network elements) or they may require operator intervention (e.g., a circuit card failure or physical link impairment such as a fiber or line cut is typically remedied via card replacement or line repair, respectively). In these cases, independent automated recovery or manual fix of a subset of elements (i.e., network or service elements) without a means for maintaining parametric consistency across all elements can wreak havoc on a system.

Although the problems in the current art of communications systems have been exemplified in the context of VoDSL systems, it should be understood that they broadly apply to a wide range of communications systems including Voice Over IP (VoIP), Voice Over ATM (VoATM), generally Voice Over Broadband (VoBB), Metropolitan Area Networks (MAN), Wide Area Networks (WAN), Local Area Networks (LAN), wireless networks and hybrid networks such as Hybrid Fiber Coax (HFC), Fiber To The Hub (FTTHB), Fiber To The Curb (FTTC), Fiber To The Home (FTTH), Fiber to the Node (FTTN), SONET rings, stars, meshes, hypercubes, Fiber Distributed Data Interface (FDDI), and related networks where coordinated provisioning and centralized management is beneficial.

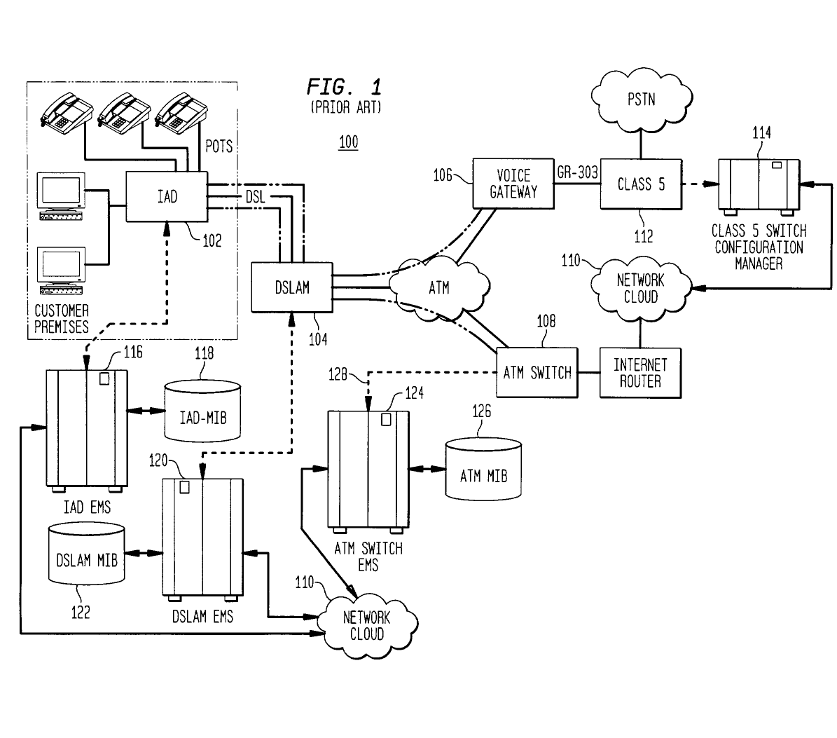

FIG. 1 depicts an exemplary prior-art shared services network 100, specifically for VoDSL. As shown, an Integrated Access Device (LAD) 102 provides customer premises equipment, such as Plain Old Telephone System (POTS) telephones and personal computers, with access to the telecommunications services provided by VoDSL network 100. Among other equipment, VoDSL network 100 includes Digital Subscriber Line Access Multiplexer (DSLAM) 104, Voice Gateway 106, Class 5 Switch 112, and Asynchronous Transfer Mode (ATM) Switch 108.

In order to support Operations, Administration, Maintenance, and Provisioning (OAM&P) (OAM&P) for network elements, such as IAD 102, DSLAM 104, Class 5 Switch 112, and ATM Switch 108, VoDSL network 100 includes an Element Management System (EMS) and a corresponding Management Information Base (MIB) for each network element. In particular, IAD EMS 116 and IAD MID 118 support OAM&P for IAD 102; DSLAM EMS 120 and DSLAM MIB 122 support OAM&P for DSLAM 104; Class 5 Switch Configuration Manager 114 support OAM&P for DSLAM 104; ATM Switch EMS 124 and ATM MIB 126 support OAM&P for ATM Switch 108.

Each EMS communicates control and provisioning information to one (or possibly more) managed network elements. For example, IAD EMS 116 communicates settings for the Virtual Path Identifier/Virtual Circuit Identifier (VPI/VCI) from its local MIB 118 to IAD 102. Each EMS also polls and/or receives alerts from its managed network elements. For example, IAD EMS 116 might receive bit-error rate status/statistics, hardware health status, or buffer-overfill alerts from LAD 102. A vendor-specific EMS is typically limited in its ability to send control and receive status from other vendor's network elements. Additionally, coordination of corresponding provisioning parameters between EMSs is burdensome and requires manual copying and checking.

Each EMS communicates to its corresponding managed network elements through various protocols and interfaces. However, it is common to use Simple Network Management Protocol (SNMP) over User Datagram Protocol (UDP) over Internet Protocol (IP) (SNMP/UDP/IP) over an adaptation layer and/or a physical layer interface of an application-specific nature. The physical layer can be any of a number of different interfaces including Ethernet (any flavor including 10baseT, 10/100baseT, Gigabit Ethernet, etc.,) Synchronous Optical Network (SONET), Fiber Distributed Data Interface (FDDI), etc. Other intermediate protocol variants may be used as well including IP over Asynchronous Transfer Mode (IP/ATM), IP/xDSL, etc. There are also intermediate protocol options that are more tailored to a specific physical layer environment. For example, in ATM networks, it is common to adhere to the Interim Local Management Interface (ILMI). ILMI is a protocol defined by the ATM Forum for setting and capturing physical layer, ATM layer, virtual path, and virtual circuit parameters on ATM interfaces. ILMI uses simple network management protocol (SNMP) messages without the UDP and IP intermediate protocol layers. When two ATM interfaces run the ILMI protocol, they exchange ILMI packets across the physical connection. The ATM interfaces encapsulate these messages in an ATM adaptation layer 5 (AAL5) trailer, segment the SNMP packet into cells, and schedule the cells for transmission. As an example, in FIG. 1, ATM Switch EMS 124 may communicate using SNMP/UPD/IP/Ethernet to the Network Cloud 110 and from there be routed to ATM Switch 108. Alternatively, ATM Switch EMS 124 may manage ATM Switch 108 directly using SNMP over ATM (AAL5) per the ILMI standard over a direct connection such as connection 128.

The communications between EMSs and their managed network elements are typically bridged and/or routed and may pass through various partial reassembly and segmentation steps along the path from manager to agent. Additionally, certain network elements might not have the intelligence (i.e., sufficient code/data memory and sufficient processing speed) to support the full SNMP protocol stack. In these cases, another network element may act as a proxy for these non-intelligent network elements. The various protocols, translations, proxy operations, and intermediate physical interfaces are consolidated for convenience of illustration into Network Cloud 110 of FIG. 1 representing a generic LAN, WAN, Intranet, Internet, VPN etc. It is sometimes the case that a device has only one physical interface on the network management side of the network. In these cases, that interface is the one that is used for network management. For example, IAD 102 of FIG. 1 might communicate to its network manager, LAD EMS 116, using an IP over ATM over xDSL (IP/ATM/xDSL) interface from LAD 102 to DSLAM 104, an IP/ATM/SONET interface from DSLAM 104 to ATM Switch 108, and an IP over WAN interface from ATM Switch 108 to LAD EMS 116 via Network Cloud 110.

As an alternative to multiple independent Element Management Systems (EMSs) with data, control, and service overlap issues, the present invention maybe embodied in an Integrated Element Management System (IEMS) that includes all the capabilities of the individual element management systems, but offers additional synergies and features.

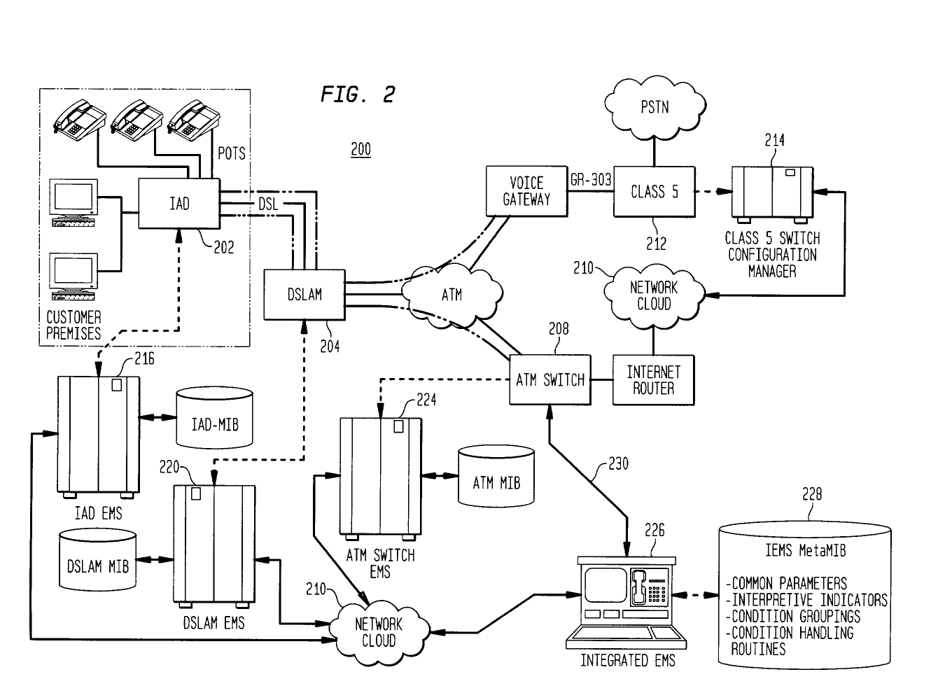

FIG. 2 depicts an exemplary shared services network 200, specifically for VoDSL, according to one embodiment of the present invention. In addition to the individual EMSs 216, 220, 214, and 224, VoDSL network 200 also includes an Integrated EMS (IEMS) 226 and an IEMS meta-MIB 228. In one embodiment of this invention, the IEMS performs centralized provisioning, validation, consistency checking, etc., for all elements and/or EMSs that manage those network elements. Alternatively, the IEMS may only be responsible and/or responsive to a subset of the EMSs and/or network elements. For example, referring to FIG. 2, IEMS 226 has assumed management responsibility for EMSs 116, 120, and 124 corresponding to network elements IAD 102, DSLAM 104, and ATM Switch 108, respectively; however it is not (in this example) communicating to the Class 5 Switch 212 or its Configuration Manager 214. Note that the more network elements that are under the coordination of the IEMS, the less severe will be the centralized provisioning, validation, and consistency checking issues for the network.

As shown in FIG. 2, IEMS 226 communicates with one or more EMSs 216, 220, 224 or one or more network elements 202, 204, 208 or a combination of both. IEMS 226 might communicate indirectly via Network Cloud 210 as indicated in FIG. 2 or directly via an application specific interface such as ILMI as discussed previously and as illustrated, for example, by interface 230. More specifically, IEMS 226 communicates shared system-wide parameters from MetaMIB 228 to one or more of the EMSs (directly or indirectly) and these parameters are then communicated or relayed, optionally after some modification, by each of these EMSs to its corresponding managed network elements. Alternatively, IEMS 226 might communicate shared system-wide parameters from MetaMIB 228 to one or more network elements 202, 204, 208 (directly or indirectly) and a local IEMS client may optionally modify these parameters before passing them to the local network element. Alternatively IEMS 226 may communicate system-wide parameters to a combination of one or more EMSs or one or more network elements and these parameters might be handled as previously discussed. The IEMS can communicate with all network elements or EMSs in any manner that is conventional for network communications including wired or wireless, optical or electrical. For example, IEMS 226 may communicate with ATM Switch 208 via Network Cloud 210 or alternatively might communicate using ILMI protocols over SONET Interface 230. IEMS 226 also performs centralized polling, event handling, and parameter checking to maintain provisioning consistency across the network 200.

IEMS 226 might additionally receive data from one or more of the EMSs or one or more of the network elements or a combination thereof, and redistribute that data to the various destinations in the end-to-end service 200 via the appropriate communication paths as discussed previously. In this embodiment, IEMS 226 performs the necessary consistency checks on the data received, validates the results, and sends the provisioning information to the managed elements or the EMSs as before. This arrangement addresses the problem concerning the parametric overlap of the provisioning values. In one alternative implementation, IEMS 226 actually can absorb or subsume the complete functionality and responsibilities of one or more of the EMSs in the network and effectively replace those EMSs.

IEMS 226 is responsible for parsing the data it receives from the individual network elements and EMSs, performing consistency checks on the data, and ultimately converting the data to appropriate format for authoritative storage in MetaMIB 228. It is also responsible for refreshing MetaMIB 228 data, as needed, to the network elements, by communication from the IEMS to the network elements or by communication from the IEMS to the relevant EMSs, where it is optionally modified prior to presentation to the network elements.

In communications systems such as that exemplified by FIG. 2, alarm events, SNMP traps, and threshold exceptions occur in the end-to-end network 200 that can be made available to the OAM&P system. Such events, traps, and threshold exceptions can be reported to an operator and service outages or impairments can be dealt with via operator intervention. However, a preferred approach is to use a condition management function (CMF) within the system that supports the automation of certain aspects of this condition handling.

According to this enhancement, error detection and correction routines are identified and grouped, so that those occurrences that can be handled algorithmically and those that might not, are known to the CMF. For example, a line error condition, where a transceiver reset/retrain would be expected to clear the fault, would be grouped with those conditions that can be handled algorithmically. Other conditions, such as the IAD becoming non-responding, might not be handled in an automated fashion. The latter occurrences might be reported traditionally, potentially after an attempt at automatic handling or recovery procedures.

Thus a preferred implementation of the invention incorporates condition grouping and handling features into a CMF within the IEMS, resulting in a logical coordination of event handling with parametric provisioning consistency. It should be understood that incorporation of the IEMS within the CMF, peer implementations of the CMF and IEMS, and other configurations of these two systems are also acceptable. FIG. 2 illustrates MetaMIB 228 associated with IEMS 226 as including a central store with not only the system-wide common parameters needed for centralized storage and consistent provisioning of the end-to-end network, but also the condition grouping and condition handling procedures associated with the CMF.

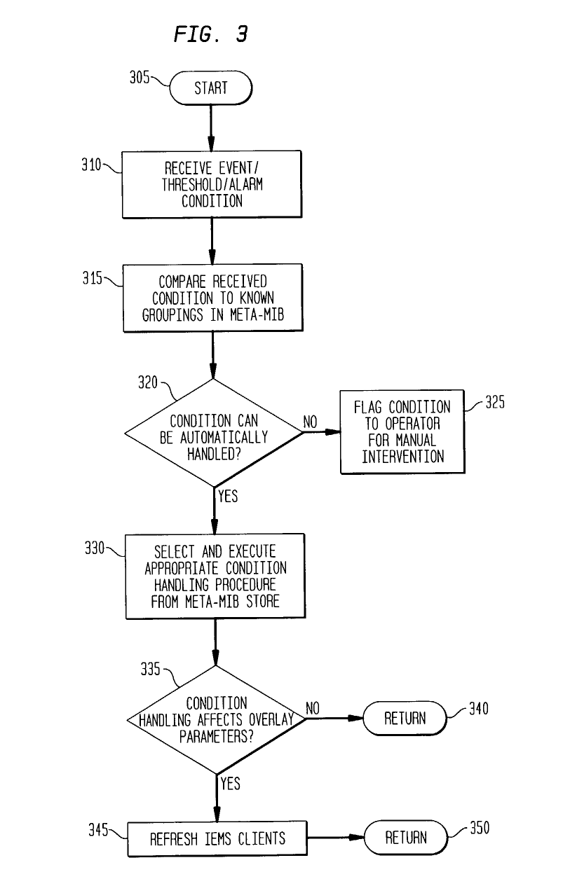

FIG. 3 depicts one embodiment of the operation of the CMF of IEMS 226 of FIG. 2. At step 305, an interrupt handling or polling routine is waiting for a condition to occur that requires action. The specifics of the condition are then received at step 310 either as part of an event/alarm/trap message or as a result of action taken on the part of the CMF to respond to the condition by polling one or more network elements and data structures within those elements to fully characterize the condition. The relevant portion of data from the MetaMIB is retrieved and a search for the condition within this data is executed at step 315. Step 315 results in finding a predetermined value or dynamically determining a value algorithmically indicating whether or not the condition can be handled in an automated fashion. This flag is checked in step 320. If the condition cannot be automatically handled, as tested in step 320, the condition is flagged to the operator for manual intervention in step 325. If the condition can be handled automatically, the appropriate handling procedure is selected from the relevant portion of the MetaMIB and executed in step 330 either exclusively on the IEMS server or in distributed fashion between the IEMS server and one or more of the IEMS clients residing on the system EMSs or system elements. If the recovery actions taken in step 330 affect the consistency of any of the system-wide parameters known to the MetaMIB as determined in the test at step 335, then the MetaMIB or an appropriate subset is refreshed from the authoritative copy to the relevant portion or entirety of the system in step 345 and the routine returns at step 350 to its starting point at step 305. Otherwise, no parameter refresh is required to the elements of the system, and the routine returns at step 340 to its starting point at step 305.

As discussed previously, IEMS 226 of FIG. 2 is responsible for parsing the data it receives from the individual network elements and EMSs, performing consistency checks on the data, and ultimately converting the data to appropriate format for authoritative storage in the MetaMIB. It is also responsible for refreshing the MetaMIB data, as needed, to the elements, by communication from the IEMS 226 to the network elements or by communication from IEMS 226 to the relevant EMSs.

It is often the case that the meaning of a parameter needs to be consistently interpreted throughout a system, or at least by multiple related elements of a system. However, due to variances in implementation between products, or varying degrees of standards compliance of these products, the format with which this parameter is presented by an EMS to an element and/or the storage format for this parameter, differs from one product to another, even if the product is of the same class or type as another (e.g., IP router).

To remedy this, the IEMS may be implemented in a server-client architecture, where the server transmits the system-consistent parameter in a standard format, along with interpretive indicators relevant to each element, and the clients perform the format translation appropriate to their element. Referring again to FIG. 2, the IEMS server might execute on IEMS 226, and the IEMS clients, which might be precompiled or dynamically downloaded into one or more of the EMSs 216, 220, 224, 214 and/or one or more of the networks elements 202, 204, 208, 212, might execute on those host products. The IEMS clients preserve the meaning of MetaMIB 228 parameters received by them, by making the format modifications relevant to their associated managed network elements. A client that is hosted by an EMS will translate the parameter as needed and pass it along to the EMS for use with that EMS's managed network elements. An IEMS client that is hosted by a network element or network element proxy will translate the parameter as needed and present the resulting value to their hosting network element or network element proxy.

As an example, in an implementation applicable to VoDSL network 200 as depicted in FIG. 2, IAD 202 is logically seen as a group of managed parameters. These parameters are specified in the Loop Emulation Services (LES) MIB-ATM Forum, “Loop Emulation Service Using AAL2,” Spec. #AF-VMOA-0175.000. One of the managed parameters for AD 202 is “cpIwfNumPotsPorts” which defines the maximum number of Plain Old Telephone System (POTS) ports enabled on LAD 202. This parameter is defined by the standard MIB as Integer 32, e.g., four octets long. However, a typical LAD might support a maximum of only 4, 8, or 16 POTS ports. These values could easily be represented within the dynamic range of one octet. Thus the developer of such a product might be hesitant, assuming the product supported the LES MIB at all, to allocate four octets to this parameter. Thus, in one implementation of the IEMS, the parameter cpIwfNumPotsPorts would be stored in the central authoritative store of the MetaMIB as Integer 32, but the IEMS client on LAD 202 would typically translate this to the implemented format, e.g., one octet. If the goal were to provision four ports, then this meaning would be guaranteed to reach LAD 202 via the IEMS server-client arrangement, independent of the actual element presentation/storage format.

Each element of the system might use different formats (e.g., word size, byte and bit order, integer and floating point representation) for equivalent managed parameters. To address this, IEMS 226 delivers the data to a combination of network elements and EMSs with embedded destination-specific interpretive indicators and embedded data format exception definitions. This means that a single item of data may be reformatted for each end-to-end service element, but the data itself will be valued consistently throughout the network. In other words, a quantity of value four in the MetaMIB will carry the same numeric significance throughout the system, independent of whether it is coded in binary, hex, or some other known format.

Tables 1 and 2 provide an example of this feature of the IEMS. Table 1 lists, for each element (Element ID, col. 1), for each MetaMIB parameter (Data Name, col. 4), the ID for the format translation (Exception ID, col. 2) that is to be applied to the parameter. Table 2 provides a lookup for the format translation given the Exception ID (EI) from Table 1.

So, for example, upon receiving the illustrated portion of the MetaMIB, the IEMS client for the central-office interworking function (CO-IWF), which typically resides physically within the DSLAM, will look to Table 1, row 2, col. 5, and read out the value “4” from its Integer 32 container. It will then read the corresponding Exception ID (EI) of “2” from row 2, col. 2. Referring to Table 2, the client will then lookup EI “2” and determine that the value needs to be represented in a 2-bit binary format before presentation to the CO-IWF. Note also that in this example the “(0-indexed)” for this EI means that ‘00b’ is used to represent a single port instead of ‘01b’, the latter of which would be the assumed representation for standard 1-indexed data. The client then converts the 32-bit integer with value “4” having representation ‘00000000,00000000,00000000,00000100b’ to the appropriate two-bit binary word with “0-indexed” representation of ‘11b’ for the value “4.”

TABLE 1
Exception IDs by Element for Each Parameter

| | Exception | Data | | Data |
|---|---|---|---|---|
| Element ID | ID (EI) | Type | Data Name | Value |
| ATM Switch | 1 | Integer 32 | NumPotsPorts | 4 |
| Voice Gateway | 1 | | | |
| CO-IWF | 2 | | | |
| IAD | — | | | |
| ATM Switch | 3 | Integer 32 | EchoCancellation | 2 |
| CO-IWF | — | | | |
| IAD | — | | | |
| ATM Switch | 2 | Integer 32 | TimingReference | 3 |
| CO-IWF | 2 | | | |
| IAD | — | | | |
| ATM Switch | — | Integer 32 | ImpairmentThreshold | Trap |
| CO-IWF | — | | | |
| IAD | — | | | |

TABLE 2
Exception ID Operations for Each Exception ID

| Exception ID (EI) | Exception ID Operation (EIO) |
|---|---|
| 1 | Translate: 8-bit binary |
| 2 | Translate: 2-bit binary (0-indexed) |
| 3 | Translate: 1-bit binary |

Likewise, Table 1, row 2, col. 1, lists Exception IDs of “1,” “1,” “2,” and “-” corresponding to the elements “ATM Switch,” “Voice Gateway,” “CO-IWF,” and “IAD” for the parameter “NumPotsPorts” which is represented as an Integer 32 of value “4” in the MetaMIB. This is stored for all of those elements as ‘00000000,00000000,0000000,00000100b’ in the MetaMIB. The referenced entries indicate, according to Table 2, that the value “4” should be translated to “8-bit binary” or “00000100b” for presentation to the ATM Switch and the Voice Gateway, translated to “2-bit binary (0-indexed) or “11b” for presentation to the CO-IWF, and not translated at all for presentation to the IAD.

Similarly, EchoCancellation, a common parameter among the ATM Switch, CO-IWF, and LAD (as illustrated by Table 1, row 3), would be translated from its Integer 32 representation with which it is stored in the MetaMIB (per Table 1, row 3, col. 3) into a 1-bit binary format (according to the “3” in Table 1, row 3, col. 2, entry 1, and the corresponding EIO for EI “3” as determined from Table 2, row 4) only for the ATM Switch, and would not be translated at all for the CO-IWF and the IAD. In this case, a value of “2” in the MetaMIB corresponds to a particular type of EchoCancellation that is relevant to the CO-IWF and IAD but transparent to the ATM Switch to the extent that it only cares whether the echo cancellation is on or off. Here the mapping implied by the “1-bit binary” translation is to be interpreted to mean that any non-zero value gets mapped to ‘1b’ while an Integer 32 value of zero gets mapped to ‘0b’.

The other “-” entries in Table 1 all indicate a “no translation” operation to the receiving IEMS client or the absence of a client in the loop (i.e., in certain embodiments, the manufacturer's network management client will accept the MetaMIB standard format and no special IEMS client is required). Finally, the EI of “2” in the first and second entries of Table 1, row 4, col. 2, indicate that, for the ATM Switch and CO-IWF, the IEMS client receiving the MIB is to translate the Integer 32 value of “3” for the “TimingReference” parameter to “2-bit binary (0-indexed)” value ‘10b’ according to Table 2, row 3.

Similarly, and by extension, the MetaMIB will contain translation and exception tables for all parameters within the system that are of interest to a particular implementation and management scope.

Another aspect of the IEMS is its ability to dynamically update the MetaMIB in response to version updates that occur from time to time on the network. These updates may occur via action of individual element managers, manual upgrade, network element replacement, or via maintenance services initiated by the IEMS itself. Means for detection of externally initiated version changes in the network and for responding appropriately are described in detail in U.S. patent application Ser. No. 09/800,684, filed on Mar. 7, 2001, as attorney docket no. Baker 23-2, incorporated herein by reference in its entirety.

Independent of the mechanism by which the updates occur, the IEMS MetaMIB management function becomes aware of version changes on the network and reacts accordingly. For example, referring again to Tables 1 and 2, if, via a version change to a vendor's MIB for a CO-IWF, the format for the NumPotsPorts parameter on the DSLAM were to change from 8-bit binary to 4-bit binary, the IEMS would dynamically modify Table 1 by changing the 3d entry in row 2, col. 2, from “2” to “4” and modify Table 2 by adding a row with EI equal “4” and Exception ID Operation (EIO) equal to “Translate: 4-bit binary.” Following this, the IEMS may elect to fully or partially refresh the appropriate elements with the upgraded MetaMIB. Note that the IEMS client software and/or hardware on the DSLAM need not change since its actions are controlled by the contents of the MetaMIB data that are passed to it from the IEMS server.

By extension, the IEMS or the CMF function could handle any occurrence that might result in a change to any of the system parameters. These parameters include those that either must be coordinated among multiple network elements in the system or those that might be stored authoritatively in the MetaMIB. As an example, it is often the case that a failure in a circuit pack in one of the network elements of a fault tolerant network might automatically be handled by rerouting of all traffic around the failed circuit. This may result in the need for update of topographical or interconnect information, the flushing of network configuration tables, etc. In one embodiment of this invention the IEMS in combination with the CMF would handle this network topology reconfiguration by applying appropriate automated reconfiguration procedures, updating the MetaMIB, and redistributing the information to those network elements or the corresponding element management systems affected. Alternatively, as discussed before, following the update of the MetaMIB, it can be broadcast to allow affected elements and element management systems to update their local relevant information from the broadcast stream. It should be understood that the functions of the IEMS and CMF are not dependent on their implementation architecture. All discussed functionality of all embodiments apply to all implementations, whether or not one or more of the IEMS and CMF are implemented as a single unit, independent units, distributed units, or in a server-client architecture, etc.

While this invention has been described with reference to illustrative embodiments, this description should not be construed in a limiting sense. Various modifications of the described embodiments, as well as other embodiments of the invention, which are apparent to persons skilled in the art to which the invention pertains are deemed to lie within the principle and scope of the invention as expressed in the following claims.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

What is claimed is:

1. A computer-implemented method for managing a distributed computer system having one or more system elements, comprising the steps of:
(a) using information to translate a value of an element parameter from an element-independent representation into an element-specific representation corresponding to a particular system element, wherein the information comprises a mapping from the element-independent representation to the element-specific representation for one or more system elements; and
(b) providing the value of the element parameter in the element-specific representation to the particular system element.

2. The invention of claim 1, wherein step (a) is implemented by an integrated element management system (IEMS) of the computer system.

3. The invention of claim 2, wherein the IEMS translates the element parameter into the element-specific representation.

4. The invention of claim 3, wherein the IEMS communicates the element parameter to the system element via an element management system (EMS) associated with the system element.

5. The invention of claim 3, wherein the IEMS communicates the element parameter to the system element independent of any EMS.

6. The invention of claim 2, wherein:
the IEMS is implemented in a distributed configuration having an IEMS server and one or more IEMS clients; and
the IEMS server communicates at least a portion of the information to each IEMS client, wherein the IEMS client uses the portion of the information to translate the element parameter into an element-specific representation.

7. The invention of claim 6, wherein at least one IEMS client resides in an element management system associated with a system element.

8. The invention of claim 6, wherein at least one IEMS client resides in a system element.

9. The invention of claim 2, wherein the information resides in a centralized store.

10. The invention of claim 9, wherein the centralized store is local to the IEMS.

11. The invention of claim 1, wherein the information identifies one or more occurrences for the computer system.

12. The invention of claim 11, wherein, for each occurrence, the information identifies whether or not the occurrence can be handled automatically.

13. The invention of claim 11, wherein, for each occurrence that can be handled automatically, the information comprises a procedure for automatic handling of the occurrence.

14. The invention of claim 13, wherein implementation of the procedure causes communication of one or more element parameters to at least one system element.

15. The invention of claim 13, wherein implementation of the procedure causes update of the value for one or more element parameters.

16. The invention of claim 13, wherein implementation of the procedure causes update of the mapping for one or more element parameters.

17. Apparatus for managing a distributed computer system having one or more system elements, comprising:
(a) an integrated element management system (IEMS); and
(b) an interface configured to provide the IEMS with access to a set of information, wherein:
the information identifies one or more element parameters, in which each element parameter has an element-independent representation, wherein, for each element parameter and for at least one system element, the information comprises a mapping from the element-independent representation to an element-specific representation applicable to the at least one system element; and
the IEMS utilizes the information to enable translation, for a particular system element, of an element parameter from its element-independent representation into the corresponding element-specific representation for use by the particular system element.

18. The invention of claim 17, wherein the IEMS is implemented in a single processor that translates the element parameter into the element-specific representation.

19. The invention of claim 18, wherein the IEMS communicates the element parameter to the system element via an element management system (EMS) associated with the system element.

20. The invention of claim 18, wherein the IEMS communicates the element parameter to the system element independent of any EMS.

21. The invention of claim 17, wherein:
the IEMS is implemented in a distributed configuration having an IEMS server and one or more IEMS clients; and
the IEMS server communicates at least a portion of the information to each IEMS client, wherein the IEMS client uses the portion of the information to translate the element parameter into the element-specific representation.

22. The invention of claim 21, wherein at least one IEMS client resides in an element management system associated with a system element.

23. The invention of claim 21, wherein at least one IEMS client resides in a system element.

24. The invention of claim 17, wherein the information resides in a centralized store.

25. The invention of claim 24, wherein the centralized store is local to the IEMS.

26. The invention of claim 17, wherein the information identifies one or more occurrences.

27. The invention of claim 26, wherein, for each occurrence, the information identifies whether or not the occurrence can be handled automatically.

28. The invention of claim 26, wherein, for each occurrence that can be handled automatically, the information comprises a procedure for automatic handling of the occurrence.

29. The invention of claim 28, wherein implementation of the procedure causes communication of one or more element parameters to at least one system element.

30. The invention of claim 28, wherein implementation of the procedure causes update of the value for one or more element parameters.

31. The invention of claim 28, wherein implementation of the procedure causes update of the mapping for one or more element parameters.

32. An apparatus for managing a distributed computer system having one or more system elements, comprising:
(a) means for using information to translate a value of an element parameter from an element-independent representation into an element-specific representation corresponding to a particular system element, wherein the information comprises a mapping from the element-independent representation to the element-specific representation for one or more system elements; and
(b) means for providing the value of the element parameter in the element-specific representation to the particular system element.
